(19) United States
(12) Patent Application Publication
(10) Pub. No.: US 2024/0357535 A1
(43) Pub. Date: Oct. 24, 2024

(54) UPDATING CAPABILITIES BEFORE CHANNEL SWITCH

(71) Applicants: Elad Oren, Tel Aviv (IL); Emily H. Qi, Gig Harbor, WA (US); Ilan Peer, Modiin JM (IL)

(72) Inventors: Elad Oren, Tel Aviv (IL); Emily H. Qi, Gig Harbor, WA (US); Ilan Peer, Modiin JM (IL)

(21) Appl. No.: 18/755,890

(22) Filed: Jun. 27, 2024

Related U.S. Application Data
(60) Provisional application No. 63/520,319, filed on Aug. 17, 2023.

(51) Int. Cl. H04W 60/04; H04W 8/22; H04W 36/06

(52) U.S. Cl. CPC H04W 60/04; H04W 8/22; H04W 36/06

(57) ABSTRACT

Methods, apparatuses, and computer readable media for updating capabilities, where a station (STA) comprises processing circuitry configured to: transmit to an access point (AP) on a first channel of a first band, an association request including a first capabilities element for a first communications standard, decode, from the AP on the first channel of the first band, an association response, the association response including a second capabilities element for the first communications standard on the first band, transmit to the AP, a channel usage request frame with a third capabilities element for a second communications standard on a second channel of a second band, and encode for transmission to the AP on the second channel of the second band, a data frame using the third capabilities element and a fourth capabilities element received from the AP on the first channel on the first band.

### PRIORITY CLAIM

This application claims the benefit of priority under 35 USC 119 (e) to U.S. Provisional Patent Application Ser. No. 63/520,319, filed Aug. 17, 2023 [reference number AF5233-Z], which is incorporated herein by reference in its entirety.

### TECHNICAL FIELD

Embodiments relate to updating the capabilities of a client before a basic server set (BSS) channel switch, in accordance with wireless local area networks (WLANs) and Wi-Fi networks including networks operating in accordance with different versions or generations of the IEEE 802.11 family of standards.

### BACKGROUND

Efficient use of the resources of a wireless local-area network (WLAN) is important to provide bandwidth and acceptable response times to the users of the WLAN. However, often there are many devices trying to share the same resources and some devices may be limited by the communication protocol they use or by their hardware bandwidth. Moreover, wireless devices may need to operate with both newer protocols and with legacy device protocols on different bands and on different channels.

### BRIEF DESCRIPTION OF THE DRAWINGS

The present disclosure is illustrated by way of example and not limitation in the figures of the accompanying drawings, in which like references indicate similar elements and in which:

FIG. 1 is a block diagram of a radio architecture in accordance with some embodiments;

FIG. 2 illustrates a front-end module circuitry for use in the radio architecture of FIG. 1 in accordance with some embodiments;

FIG. 3 illustrates a radio IC circuitry for use in the radio architecture of FIG. 1 in accordance with some embodiments;

FIG. 4 illustrates a baseband processing circuitry for use in the radio architecture of FIG. 1 in accordance with some embodiments;

FIG. 5 illustrates a WLAN in accordance with some embodiments;

FIG. 6 illustrates a block diagram of an example machine upon which any one or more of the techniques (e.g., methodologies) discussed herein may perform;

FIG. 7 illustrates a block diagram of an example wireless device upon which any one or more of the techniques (e.g., methodologies or operations) discussed herein may perform;

FIG. 8 illustrates multi-link devices (MLD) s, in accordance with some embodiments;

FIG. 9 illustrates a channel usage element, in accordance with some embodiments;

FIG. 10 illustrates a channel usage request frame, in accordance with some embodiments;

FIG. 11 illustrates a method for updating capabilities before channel switch, in accordance with some embodiments;

FIG. 12 illustrates a method for updating capabilities before channel switch, in accordance with some embodiments;

FIG. 13 illustrates a method for updating capabilities before channel switch, in accordance with some embodiments;

FIG. 14 illustrates a method for updating capabilities before channel switch, in accordance with some embodiments.

### DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

FIG. 1 is a block diagram of a radio architecture 100 in accordance with some embodiments. Radio architecture 100 may include radio front-end module (FEM) circuitry 104, radio IC circuitry 106 and baseband processing circuitry 108. Radio architecture 100 as shown includes both Wireless Local Area Network (WLAN) functionality and Bluetooth® (BT) functionality although embodiments are not so limited. In this disclosure, “WLAN” and “Wi-Fi” are used interchangeably.

FEM circuitry 104 may include a WLAN or Wi-Fi FEM circuitry 104A and a Bluetooth® (BT) FEM circuitry 104B. The WLAN FEM circuitry 104A may include a receive signal path comprising circuitry configured to operate on WLAN RF signals received from one or more antennas 101, to amplify the received signals and to provide the amplified versions of the received signals to the WLAN radio IC circuitry 106A for further processing. The BT FEM circuitry 104B may include a receive signal path which may include circuitry configured to operate on BT RF signals received from one or more antennas 101, to amplify the received signals and to provide the amplified versions of the received signals to the BT radio IC circuitry 106B for further processing. FEM circuitry 104A may also include a transmit signal path which may include circuitry configured to amplify WLAN signals provided by the radio IC circuitry 106A for wireless transmission by one or more of the antennas 101. In addition, FEM circuitry 104B may also include a transmit signal path which may include circuitry configured to amplify BT signals provided by the radio IC circuitry 106B for wireless transmission by the one or more antennas. In the embodiment of FIG. 1, although FEM circuitry 104A and FEM circuitry 104B are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 106 as shown may include WLAN radio IC circuitry 106A and BT radio IC circuitry 106B. The WLAN radio IC circuitry 106A may include a receive signal path which may include circuitry to down-convert WLAN RF signals received from the FEM circuitry 104A and provide baseband signals to WLAN baseband processing circuitry 108A. BT radio IC circuitry 106B may in turn include a receive signal path which may include circuitry to down-convert BT RF signals received from the FEM circuitry 104B and provide baseband signals to BT baseband processing circuitry 108B. WLAN radio IC circuitry 106A may also include a transmit signal path which may include circuitry to up-convert WLAN baseband signals provided by the WLAN baseband processing circuitry 108A and provide WLAN RF output signals to the FEM circuitry 104A for subsequent wireless transmission by the one or more antennas 101. BT radio IC circuitry 106B may also include a transmit signal path which may include circuitry to up-convert BT baseband signals provided by the BT baseband processing circuitry 108B and provide BT RF output signals to the FEM circuitry 104B for subsequent wireless transmission by the one or more antennas 101. In the embodiment of FIG. 1, although radio IC circuitries 106A and 106B are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuity 108 may include a WLAN baseband processing circuitry 108A and a BT baseband processing circuitry 108B. The WLAN baseband processing circuitry 108A may include a memory, such as, for example, a set of RAM arrays in a Fast Fourier Transform or Inverse Fast Fourier Transform block (not shown) of the WLAN baseband processing circuitry 108A. Each of the WLAN baseband processing circuitry 108A and the BT baseband circuitry 108B may further include one or more processors and control logic to process the signals received from the corresponding WLAN or BT receive signal path of the radio IC circuitry 106, and to also generate corresponding WLAN or BT baseband signals for the transmit signal path of the radio IC circuitry 106. Each of the baseband processing circuitries 108A and 108B may further include physical layer (PHY) and medium access control layer (MAC) circuitry, and may further interface with application processor 111 for generation and processing of the baseband signals and for controlling operations of the radio IC circuitry 106.

Referring still to FIG. 1, according to the shown embodiment, WLAN-BT coexistence circuitry 113 may include logic providing an interface between the WLAN baseband processing circuitry 108A and the BT baseband circuitry 108B to enable use cases requiring WLAN and BT coexistence. In addition, a switch 103 may be provided between the WLAN FEM circuitry 104A and the BT FEM circuitry 104B to allow switching between the WLAN and BT radios according to application needs. In addition, although the antennas 101 are depicted as being respectively connected to the WLAN FEM circuitry 104A and the BT FEM circuitry 104B, embodiments include within their scope the sharing of one or more antennas as between the WLAN and BT FEMs, or the provision of more than one antenna connected to each of FEM circuitry 104A or FEM circuitry 104B.

In some embodiments, the front-end module circuitry 104, the radio IC circuitry 106, and baseband processing circuitry 108 may be provided on a single radio card, such as wireless radio card 102. In some other embodiments, the one or more antennas 101, the FEM circuitry 104 and the radio IC circuitry 106 may be provided on a single radio card. In some other embodiments, the radio IC circuitry 106 and the baseband processing circuitry 108 may be provided on a single chip or IC, such as IC 112.

In some embodiments, the wireless radio card 102 may include a WLAN radio card and may be configured for Wi-Fi communications, although the scope of the embodiments is not limited in this respect. In some of these embodiments, the radio architecture 100 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 100 may be part of a Wi-Fi communication station (STA) such as a wireless access point (AP), a base station or a mobile device including a Wi-Fi device. In some of these embodiments, radio architecture 100 may be configured to transmit and receive signals in accordance with specific communication standards and/or protocols, such as any of the Institute of Electrical and Electronics Engineers (IEEE) standards including, IEEE 802.11n-2009, IEEE 802.11-2012, IEEE 802.11-2016, IEEE 802.11ac, and/or IEEE 802.11ax standards and/or proposed specifications for WLANs, although the scope of embodiments is not limited in this respect. Radio architecture 100 may also be suitable to transmit and/or receive communications in accordance with other techniques and standards.

In some embodiments, the radio architecture 100 may be configured for high-efficiency (HE) Wi-Fi (HEW) communications in accordance with the IEEE 802.11ax standard. In these embodiments, the radio architecture 100 may be configured to communicate in accordance with an OFDMA technique, although the scope of the embodiments is not limited in this respect.

In some other embodiments, the radio architecture 100 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 1, the BT baseband circuitry 108B may be compliant with a Bluetooth® (BT) connectivity standard such as Bluetooth®, Bluetooth® 4.0 or Bluetooth® 5.0, or any other iteration of the Bluetooth® Standard. In embodiments that include BT functionality as shown for example in FIG. 1, the radio architecture 100 may be configured to establish a BT synchronous connection oriented (SCO) link and/or a BT low energy (BT LE) link. In some of the embodiments that include functionality, the radio architecture 100 may be configured to establish an extended SCO (cSCO) link for BT communications, although the scope of the embodiments is not limited in this respect. In some of these embodiments that include a BT functionality, the radio architecture may be configured to engage in a BT Asynchronous Connection-Less (ACL) communications, although the scope of the embodiments is not limited in this respect. In some embodiments, as shown in FIG. 1, the functions of a BT radio card and WLAN radio card may be combined on a single wireless radio card, such as single wireless radio card 102, although embodiments are not so limited, and include within their scope discrete WLAN and BT radio cards

In some embodiments, the radio architecture 100 may include other radio cards, such as a cellular radio card configured for cellular (e.g., 3GPP such as LTE, LTE-Advanced or 5G communications).

In some IEEE 802.11 embodiments, the radio architecture 100 may be configured for communication over various channel bandwidths including bandwidths having center frequencies of about nine hundred MHz, 2.4 GHZ, 5 GHZ, and bandwidths of about 1 MHZ, 2 MHz, 2.5 MHz, 4 MHZ, 5 MHz, 8 MHz, 10 MHZ, 16 MHz, 20 MHz, 40 MHz, 80 MHz (with contiguous bandwidths) or 80+80 MHz (160 MHz) (with non-contiguous bandwidths). In some embodiments, a 320 MHz channel bandwidth may be used. The scope of the embodiments is not limited with respect to the above center frequencies however.

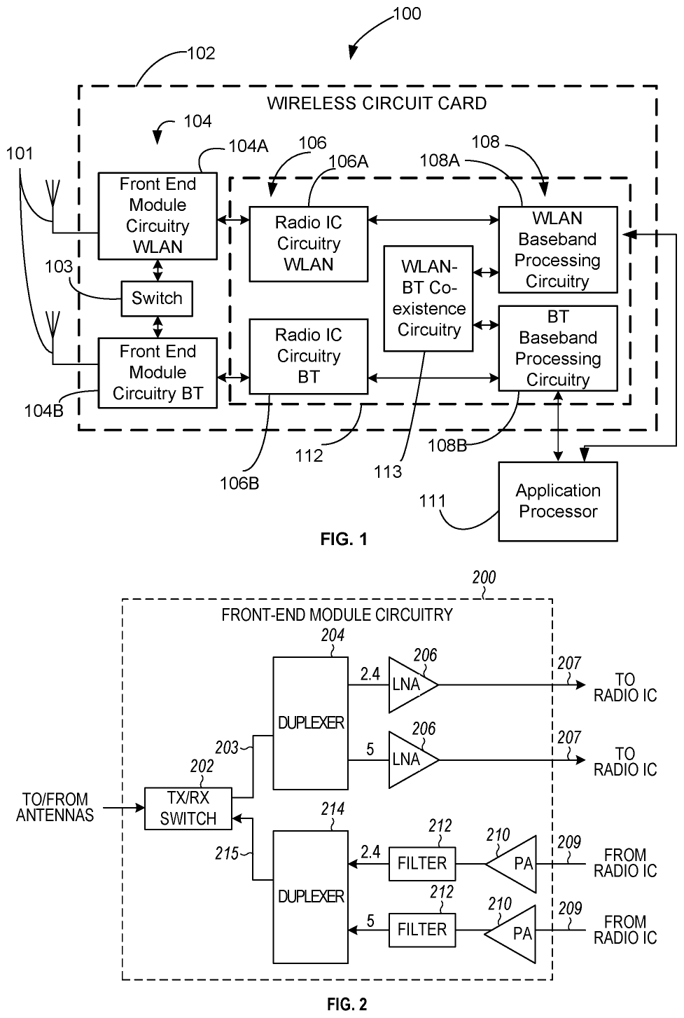

FIG. 2 illustrates FEM circuitry 200 in accordance with some embodiments. The FEM circuitry 200 is one example of circuitry that may be suitable for use as the WLAN and/or BT FEM circuitry 104A/104B (FIG. 1), although other circuitry configurations may also be suitable.

In some embodiments, the FEM circuitry 200 may include a TX/RX switch 202 to switch between transmit mode and receive mode operation. The FEM circuitry 200 may include a receive signal path and a transmit signal path. The receive signal path of the FEM circuitry 200 may include a low-noise amplifier (LNA) 206 to amplify received RF signals 203 and provide the amplified received RF signals 207 as an output (e.g., to the radio IC circuitry 106 (FIG. 1)). The transmit signal path of the circuitry 200 may include a power amplifier (PA) to amplify input RF signals 209 (e.g., provided by the radio IC circuitry 106), and one or more filters 212, such as band-pass filters (BPFs), low-pass filters (LPFs) or other types of filters, to generate RF signals 215 for subsequent transmission (e.g., by one or more of the antennas 101 (FIG. 1)).

In some dual-mode embodiments for Wi-Fi communication, the FEM circuitry 200 may be configured to operate in either the 2.4 GHz frequency spectrum or the 5 GHz frequency spectrum. In these embodiments, the receive signal path of the FEM circuitry 200 may include a receive signal path duplexer 204 to separate the signals from each spectrum as well as provide a separate LNA 206 for each spectrum as shown. In these embodiments, the transmit signal path of the FEM circuitry 200 may also include a power amplifier 210 and a filter 212, such as a BPF, a LPF or another type of filter for each frequency spectrum and a transmit signal path duplexer 214 to provide the signals of one of the different spectrums onto a single transmit path for subsequent transmission by the one or more of the antennas 101 (FIG. 1). In some embodiments, BT communications may utilize the 2.4 GHZ signal paths and may utilize the same FEM circuitry 200 as the one used for WLAN communications.

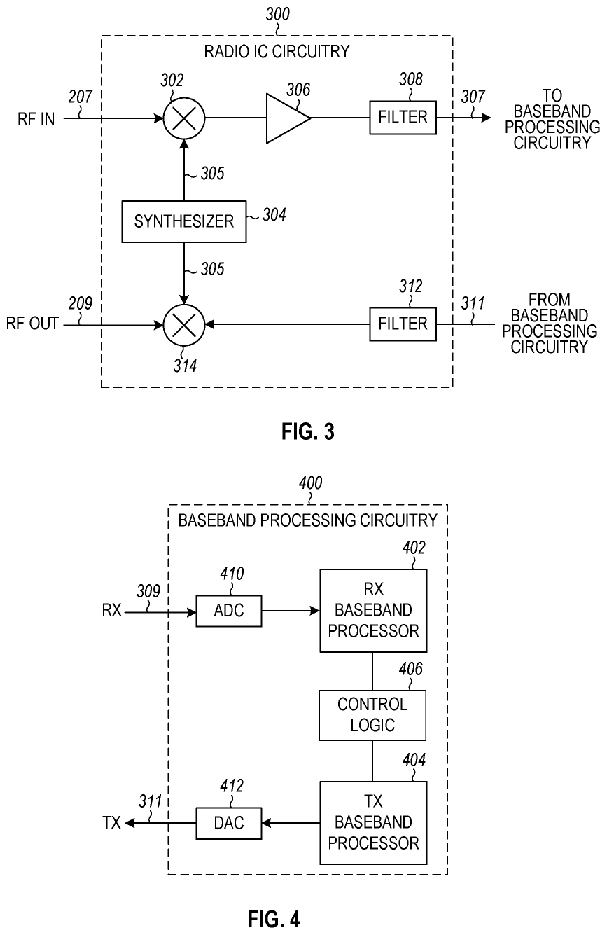

FIG. 3 illustrates radio integrated circuit (IC) circuitry 300 in accordance with some embodiments. The radio IC circuitry 300 is one example of circuitry that may be suitable for use as the WLAN or BT radio IC circuitry 106A/106B (FIG. 1), although other circuitry configurations may also be suitable.

In some embodiments, the radio IC circuitry 300 may include a receive signal path and a transmit signal path. The receive signal path of the radio IC circuitry 300 may include at least mixer circuitry 302, such as, for example, down-conversion mixer circuitry, amplifier circuitry 306 and filter circuitry 308. The transmit signal path of the radio IC circuitry 300 may include at least filter circuitry 312 and mixer circuitry 314, such as, for example, up-conversion mixer circuitry. Radio IC circuitry 300 may also include synthesizer circuitry 304 for synthesizing a frequency 305 for use by the mixer circuitry 302 and the mixer circuitry 314. The mixer circuitry 302 and/or 314 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 3 illustrates only a simplified version of a radio IC circuitry, and may include, although not shown, embodiments where each of the depicted circuitries may include more than one component. For instance, mixer circuitry 302 and/or 314 may each include one or more mixers, and filter circuitries 308 and/or 312 may each include one or more filters, such as one or more BPFs and/or LPFs according to application needs. For example, when mixer circuitries are of the direct-conversion type, they may each include two or more mixers.

In some embodiments, mixer circuitry 302 may be configured to down-convert RF signals 207 received from the FEM circuitry 104 (FIG. 1) based on the synthesized frequency 305 provided by synthesizer circuitry 304. The amplifier circuitry 306 may be configured to amplify the down-converted signals and the filter circuitry 308 may include a LPF configured to remove unwanted signals from the down-converted signals to generate output baseband signals 307. Output baseband signals 307 may be provided to the baseband processing circuitry 108 (FIG. 1) for further processing. In some embodiments, the output baseband signals 307 may be zero-frequency baseband signals, although this is not a requirement. In some embodiments, mixer circuitry 302 may comprise passive mixers, although the scope of the embodiments is not limited in this respect.

In some embodiments, the mixer circuitry 314 may be configured to up-convert input baseband signals 311 based on the synthesized frequency 305 provided by the synthesizer circuitry 304 to generate RF output signals 209 for the FEM circuitry 104. The baseband signals 311 may be provided by the baseband processing circuitry 108 and may be filtered by filter circuitry 312. The filter circuitry 312 may include a LPF or a BPF, although the scope of the embodiments is not limited in this respect.

In some embodiments, the mixer circuitry 302 and the mixer circuitry 314 may each include two or more mixers and may be arranged for quadrature down-conversion and/or up-conversion respectively with the help of synthesizer circuitry 304. In some embodiments, the mixer circuitry 302 and the mixer circuitry 314 may each include two or more mixers each configured for image rejection (e.g., Hartley image rejection). In some embodiments, the mixer circuitry 302 and the mixer circuitry 314 may be arranged for direct down-conversion and/or direct up-conversion, respectively. In some embodiments, the mixer circuitry 302 and the mixer circuitry 314 may be configured for super-heterodyne operation, although this is not a requirement.

Mixer circuitry 302 may comprise, according to one embodiment: quadrature passive mixers (e.g., for the in-phase (I) and quadrature phase (Q) paths). In such an embodiment, RF input signal 207 from FIG. 3 may be down-converted to provide I and Q baseband output signals to be sent to the baseband processor

Quadrature passive mixers may be driven by zero and ninety-degree time-varying LO switching signals provided by a quadrature circuitry which may be configured to receive a LO frequency (f_{LO}) from a local oscillator or a synthesizer, such as LO frequency 305 of synthesizer circuitry 304 (FIG. 3). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have a 25% duty cycle and a 50% offset. In some embodiments, each branch of the mixer circuitry (e.g., the in-phase (I) and quadrature phase (Q) path) may operate at a 25% duty cycle, which may result in a significant reduction is power consumption.

The RF input signal 207 (FIG. 2) may comprise a balanced signal, although the scope of the embodiments is not limited in this respect. The I and Q baseband output signals may be provided to low-nose amplifier, such as amplifier circuitry 306 (FIG. 3) or to filter circuitry 308 (FIG. 3).

In some embodiments, the output baseband signals 307 and the input baseband signals 311 may be analog baseband signals, although the scope of the embodiments is not limited in this respect. In some alternate embodiments, the output baseband signals 307 and the input baseband signals 311 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 304 may be a fractional-N synthesizer or a fractional N/N+1 synthesizer, although the scope of the embodiments is not limited in this respect as other types of frequency synthesizers may be suitable. For example, synthesizer circuitry 304 may be a delta-sigma synthesizer, a frequency multiplier, or a synthesizer comprising a phase-locked loop with a frequency divider. According to some embodiments, the synthesizer circuitry 304 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuity 304 may be provided by a voltage controlled oscillator (VCO), although that is not a requirement. A divider control input may further be provided by either the baseband processing circuitry 108 (FIG. 1) or the application processor 111 (FIG. 1) depending on the desired output frequency 305. In some embodiments, a divider control input (e.g., N) may be determined from a look-up table (e.g., within a Wi-Fi card) based on a channel number and a channel center frequency as determined or indicated by the application processor 111.

In some embodiments, synthesizer circuitry 304 may be configured to generate a carrier frequency as the output frequency 305, while in other embodiments, the output frequency 305 may be a fraction of the carrier frequency (e.g., one-half the carrier frequency, one-third the carrier frequency). In some embodiments, the output frequency 305 may be a LO frequency (f_{LO}).

FIG. 4 illustrates a functional block diagram of baseband processing circuitry 400 in accordance with some embodiments. The baseband processing circuitry 400 is one example of circuitry that may be suitable for use as the baseband processing circuitry 108 (FIG. 1), although other circuitry configurations may also be suitable. The baseband processing circuitry 400 may include a receive baseband processor (RX BBP) 402 for processing receive baseband signals 309 provided by the radio IC circuitry 106 (FIG. 1) and a transmit baseband processor (TX BBP) 404 for generating transmit baseband signals 311 for the radio IC circuitry 106. The baseband processing circuitry 400 may also include control logic 406 for coordinating the operations of the baseband processing circuitry 400.

In some embodiments (e.g., when analog baseband signals are exchanged between the baseband processing circuitry 400 and the radio IC circuitry 106), the baseband processing circuitry 400 may include ADC 410 to convert analog baseband signals received from the radio IC circuitry 106 to digital baseband signals for processing by the RX BBP 402. In these embodiments, the baseband processing circuitry 400 may also include DAC 412 to convert digital baseband signals from the TX BBP 404 to analog baseband signals.

In some embodiments that communicate OFDM signals or OFDMA signals, such as through baseband processing circuitry 108A, the TX BBP 404 may be configured to generate OFDM or OFDMA signals as appropriate for transmission by performing an inverse fast Fourier transform (IFFT). The RX BBP 402 may be configured to process received OFDM signals or OFDMA signals by performing an FFT. In some embodiments, the RX BBP 402 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring to FIG. 1, in some embodiments, the antennas 101 (FIG. 1) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 101 may each include a set of phased-array antennas, although embodiments are not so limited.

Although the radio architecture 100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

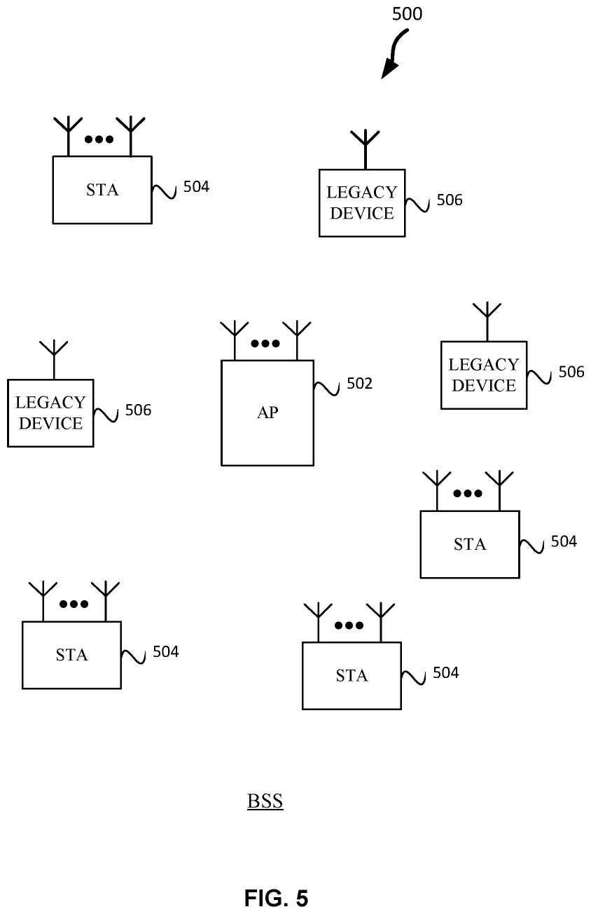

FIG. 5 illustrates a WLAN 500 in accordance with some embodiments. The WLAN 500 may comprise a basis service set (BSS) that may include an access point (AP) AP 502, a plurality of stations (STAs) STAs 504, and a plurality of legacy devices 506. In some embodiments, the STAs 504 and/or AP 502 are configured to operate in accordance with IEEE 802.11be extremely high throughput (EHT), WiFi 8 IEEE 802.11 ultra-high throughput (UHT), high efficiency (HE) IEEE 802.11ax, IEEE 802.11bn next generation or ultra-high reliability (UHR), and/or another IEEE 802.11 wireless communication standard. In some embodiments, the STAs 504 and/or AP 502 are configured to operate in accordance with IEEE P802.11be, and/or IEEE P802.11-REVme™, both of which are hereby included by reference in their entirety.

The AP 502 may use other communications protocols as well as the IEEE 802.11 protocol. The terms here may be termed differently in accordance with some embodiments. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO). There may be more than one AP 502 that is part of an extended service set (ESS). A controller (not illustrated) may store information that is common to the more than one APs 502 and may control more than one BSS, e.g., assign primary channels, colors, etc. AP 502 may be connected to the internet.

The legacy devices 506 may operate in accordance with one or more of IEEE 802.11 a/b/g/n/ac/ad/af/ah/aj/ay/ax/uht, or another legacy wireless communication standard. The legacy devices 506 may be STAs or IEEE STAs. The STAs 504 may be wireless transmit and receive devices such as cellular telephone, portable electronic wireless communication devices, smart telephone, handheld wireless device, wireless glasses, wireless watch, wireless personal device, tablet, or another device that may be transmitting and receiving using the IEEE 802.11 protocol such as IEEE 802.11be or another wireless protocol.

The AP 502 may communicate with legacy devices 506 in accordance with legacy IEEE 802.11 communication techniques. In example embodiments, the AP 502 may also be configured to communicate with STAs 504 in accordance with legacy IEEE 802.11 communication techniques.

In some embodiments, a HE, EHT, UHT frames may be configurable to have the same bandwidth as a channel. The HE, EHT, UHT frame may be a physical Layer Convergence Procedure (PLCP) Protocol Data Unit (PPDU). In some embodiments, PPDU may be an abbreviation for physical layer protocol data unit (PPDU). In some embodiments, there may be different types of PPDUs that may have different fields and different physical layers and/or different media access control (MAC) layers. For example, a single user (SU) PPDU, downlink (DL) PPDU, multiple-user (MU) PPDU, extended-range (ER) SU PPDU, and/or trigger-based (TB) PPDU. In some embodiments EHT may be the same or similar as HE PPDUs.

The bandwidth of a channel may be 20 MHz, 40 MHz, or 80 MHz, 80+80 MHZ, 160 MHz, 160+160 MHz, 320 MHz, 320+320 MHz, 640 MHz bandwidths. In some embodiments, the bandwidth of a channel less than 20 MHz may be 1 MHZ, 1.25 MHz, 2.03 MHZ, 2.5 MHz, 4.06 MHz, 5 MHz and 10 MHz, or a combination thereof or another bandwidth that is less or equal to the available bandwidth may also be used. In some embodiments the bandwidth of the channels may be based on a number of active data subcarriers. In some embodiments the bandwidth of the channels is based on 26, 52, 106, 242, 484, 996, or 2×996 active data subcarriers or tones that are spaced by 20 MHz. In some embodiments the bandwidth of the channels is 256 tones spaced by 20 MHz. In some embodiments the channels are multiple of 26 tones or a multiple of 20 MHz. In some embodiments a 20 MHz channel may comprise 242 active data subcarriers or tones, which may determine the size of a Fast Fourier Transform (FFT). An allocation of a bandwidth or a number of tones or sub-carriers may be termed a resource unit (RU) allocation in accordance with some embodiments.

In some embodiments, the 26-subcarrier RU and 52-subcarrier RU are used in the 20 MHz, 40 MHz, 80 MHz, 160 MHz and 80+80 MHz OFDMA HE PPDU formats. In some embodiments, the 106-subcarrier RU is used in the 20 MHz, 40 MHZ, 80 MHz, 160 MHz and 80+80 MHz OFDMA and MU-MIMO HE PPDU formats. In some embodiments, the 242-subcarrier RU is used in the 40 MHz, 80 MHZ, 160 MHz and 80+80 MHz OFDMA and MU-MIMO HE PPDU formats. In some embodiments, the 484-subcarrier RU is used in the 80 MHZ, 160 MHz and 80+80 MHz OFDMA and MU-MIMO HE PPDU formats. In some embodiments, the 996-subcarrier RU is used in the 160 MHz and 80+80 MHZ OFDMA and MU-MIMO HE PPDU formats.

A HE, EHT, UHT, UHT, or UHR frame may be configured for transmitting a number of spatial streams, which may be in accordance with MU-MIMO and may be in accordance with OFDMA. In other embodiments, the AP 502, STA 504, and/or legacy device 506 may also implement different technologies such as code division multiple access (CDMA) 2000, CDMA 2000 1X, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), Bluetooth®, low-power Bluetooth®, or other technologies.

In accordance with some IEEE 802.11 embodiments, e.g., IEEE 802.11EHT/ax/be embodiments, a HE AP 502 may operate as a master station which may be arranged to contend for a wireless medium (e.g., during a contention period) to receive exclusive control of the medium for a transmission opportunity (TXOP). The AP 502 may transmit an EHT/HE trigger frame transmission, which may include a schedule for simultaneous UL/DL transmissions from STAs 504. The AP 502 may transmit a time duration of the TXOP and sub-channel information. During the TXOP, STAs 504 may communicate with the AP 502 in accordance with a non-contention based multiple access technique such as OFDMA or MU-MIMO. This is unlike conventional WLAN communications in which devices communicate in accordance with a contention-based communication technique, rather than a multiple access technique. During the HE, EHT, UHR control period, the AP 502 may communicate with STAs 504 using one or more HE or EHT frames. During the TXOP, the HE STAs 504 may operate on a sub-channel smaller than the operating range of the AP 502. During the TXOP, legacy stations refrain from communicating. The legacy stations may need to receive the communication from the HE AP 502 to defer from communicating.

In accordance with some embodiments, during the TXOP the STAs 504 may contend for the wireless medium with the legacy devices 506 being excluded from contending for the wireless medium during the master-sync transmission. In some embodiments the trigger frame may indicate an UL-MU-MIMO and/or UL OFDMA TXOP. In some embodiments, the trigger frame may include a DL UL-MU-MIMO and/or DL OFDMA with a schedule indicated in a preamble portion of trigger frame.

In some embodiments, the multiple-access technique used during the HE or EHT TXOP may be a scheduled OFDMA technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique. In some embodiments, the multiple access technique may be a Code division multiple access (CDMA).

The AP 502 may also communicate with legacy devices 506 and/or STAs 504 in

accordance with legacy IEEE 802.11 communication techniques. In some embodiments, the AP 502 may also be configurable to communicate with STAs 504 outside the TXOP in accordance with legacy IEEE 802.11 or IEEE 802.11EHT/UHR communication techniques, although this is not a requirement.

In some embodiments the STA 504 may be a “group owner” (GO) for peer-to-peer modes of operation. A wireless device may be a STA 504 or a HE AP 502. The STA 504 may be termed a non-access point (AP) (non-AP) STA 504, in accordance with some embodiments.

In some embodiments, the STA 504 and/or AP 502 may be configured to operate in accordance with IEEE 802.11mc. In example embodiments, the radio architecture of FIG. 1 is configured to implement the STA 504 and/or the AP 502. In example embodiments, the front-end module circuitry of FIG. 2 is configured to implement the STA 504 and/or the AP 502. In example embodiments, the radio IC circuitry of FIG. 3 is configured to implement the HE STA 504 and/or the AP 502. In example embodiments, the base-band processing circuitry of FIG. 4 is configured to implement the STA 504 and/or the AP 502.

In example embodiments, the STAs 504, AP 502, an apparatus of the STA 504, and/or an apparatus of the AP 502 may include one or more of the following: the radio architecture of FIG. 1, the front-end module circuitry of FIG. 2, the radio IC circuitry of FIG. 3, and/or the base-band processing circuitry of FIG. 4.

In example embodiments, the radio architecture of FIG. 1, the front-end module circuitry of FIG. 2, the radio IC circuitry of FIG. 3, and/or the base-band processing circuitry of FIG. 4 may be configured to perform the methods and operations/functions herein described in conjunction with FIGS. 1-14.

In example embodiments, the STAs 504 and/or the AP 502 are configured to perform the methods and operations/functions described herein in conjunction with FIGS. 1-14. In example embodiments, an apparatus of the STA 504 and/or an apparatus of the AP 502 are configured to perform the methods and functions described herein in conjunction with FIGS. 1-14. The term Wi-Fi may refer to one or more of the IEEE 802.11 communication standards. AP and STA may refer to EHT/HE access point and/or EHT/HE station as well as legacy devices 506.

In some embodiments, a HE AP STA may refer to an AP 502 and/or STAs 504 that are operating as EHT APs 502. In some embodiments, when a STA 504 is not operating as an AP, it may be referred to as a non-AP STA or non-AP. In some embodiments, STA 504 may be referred to as either an AP STA or a non-AP. The AP 502 may be part of, or affiliated with, an AP MLD 808, e.g., AP1 830, AP2 832, or AP3 834. The STAs 504 may be part of, or affiliated with, a non-AP MLD 809, which may be termed a ML non-AP logical entity. The BSS may be part of an extended service set (ESS), which may include multiple APs, access to the internet, and may include one or more management devices.

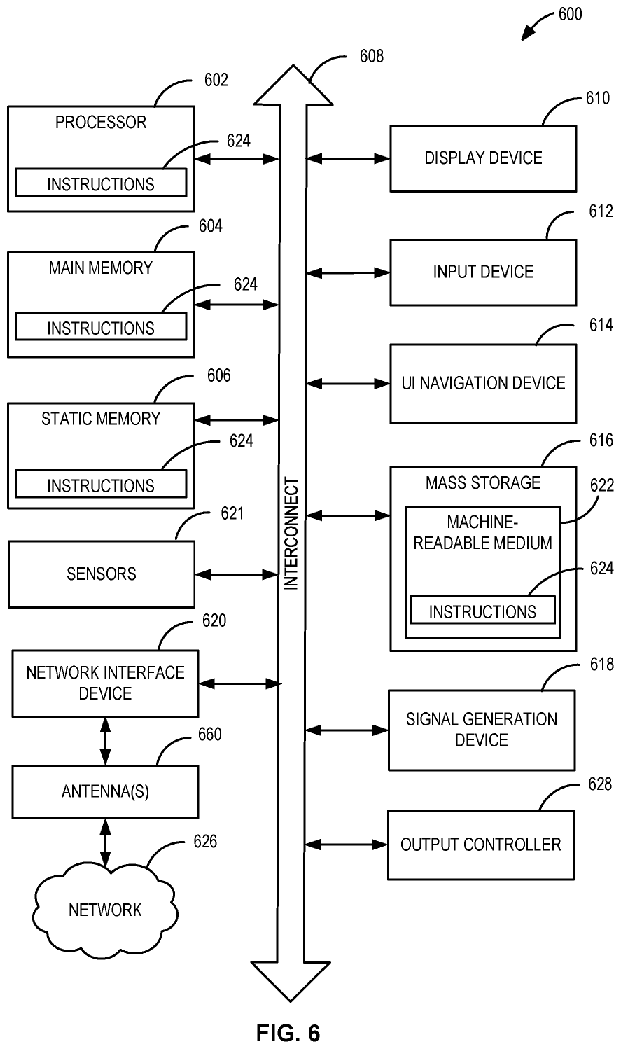

FIG. 6 illustrates a block diagram of an example machine 600 upon which any one or more of the techniques (e.g., methodologies) discussed herein may perform. In alternative embodiments, the machine 600 may operate as a standalone device or may be connected (e.g., networked) to other machines. In a networked deployment, the machine 600 may operate in the capacity of a server machine, a client machine, or both in server-client network environments. In an example, the machine 600 may act as a peer machine in peer-to-peer (P2P) (or other distributed) network environment. The machine 600 may be a HE AP 502, EVT STA 504, personal computer (PC), a tablet PC, a set-top box (STB), a personal digital assistant (PDA), a portable communications device, a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Machine (e.g., computer system) 600 may include a hardware processor 602 (e.g., a central processing unit (CPU), a graphics processing unit (GPU), a hardware processor core, or any combination thereof), a main memory 604 and a static memory 606, some or all of which may communicate with each other via an interlink (e.g., bus) 608.

Specific examples of main memory 604 include Random Access Memory (RAM), and semiconductor memory devices, which may include, in some embodiments, storage locations in semiconductors such as registers. Specific examples of static memory 606 include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; RAM; and CD-ROM and DVD-ROM disks.

The machine 600 may further include a display device 610, an input device 612 (e.g., a keyboard), and a user interface (UI) navigation device 614 (e.g., a mouse). In an example, the display device 610, input device 612 and UI navigation device 614 may be a touch screen display. The machine 600 may additionally include a mass storage (e.g., drive unit) 616, a signal generation device 618 (e.g., a speaker), a network interface device 620, and one or more sensors 621, such as a global positioning system (GPS) sensor, compass, accelerometer, or other sensor. The machine 600 may include an output controller 628, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.). In some embodiments the processor 602 and/or instructions 624 may comprise processing circuitry and/or transceiver circuitry.

The mass storage 616 device may include a machine readable medium 622 on which is stored one or more sets of data structures or instructions 624 (e.g., software) embodying or utilized by any one or more of the techniques or functions described herein. The instructions 624 may also reside, completely or at least partially, within the main memory 604, within static memory 606, or within the hardware processor 602 during execution thereof by the machine 600. In an example, one or any combination of the hardware processor 602, the main memory 604, the static memory 606, or the mass storage 616 device may constitute machine readable media.

Specific examples of machine-readable media may include: non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

While the machine readable medium 622 is illustrated as a single medium, the term “machine readable medium” may include a single medium or multiple media (e.g., a centralized or distributed database, and/or associated caches and servers) configured to store the one or more instructions 624.

An apparatus of the machine 600 may be one or more of a hardware processor 602 (e.g., a central processing unit (CPU), a graphics processing unit (GPU), a hardware processor core, or any combination thereof), a main memory 604 and a static memory 606, sensors 621, network interface device 620, antennas 660, a display device 610, an input device 612, a UI navigation device 614, a mass storage 616, instructions 624, a signal generation device 618, and an output controller 628. The apparatus may be configured to perform one or more of the methods and/or operations disclosed herein. The apparatus may be intended as a component of the machine 600 to perform one or more of the methods and/or operations disclosed herein, and/or to perform a portion of one or more of the methods and/or operations disclosed herein. In some embodiments, the apparatus may include a pin or other means to receive power. In some embodiments, the apparatus may include power conditioning hardware.

The term “machine readable medium” may include any medium that is capable of storing, encoding, or carrying instructions for execution by the machine 600 and that cause the machine 600 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks. In some examples, machine readable media may include non-transitory machine-readable media. In some examples, machine readable media may include machine readable media that is not a transitory propagating signal.

The instructions 624 may further be transmitted or received over a communications network 626 using a transmission medium via the network interface device 620 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others.

In an example, the network interface device 620 may include one or more physical jacks (e.g., Ethernet, coaxial, or phone jacks) or one or more antennas to connect to the communications network 626. In an example, the network interface device 620 may include one or more antennas 660 to wirelessly communicate using at least one of single-input multiple-output (SIMO), multiple-input multiple-output (MIMO), or multiple-input single-output (MISO) techniques. In some examples, the network interface device 620 may wirelessly communicate using Multiple User MIMO techniques. The term “transmission medium” shall be taken to include any intangible medium that is capable of storing, encoding or carrying instructions for execution by the machine 600, and includes digital or analog communications signals or other intangible medium to facilitate communication of such software.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Some embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; flash memory, etc.

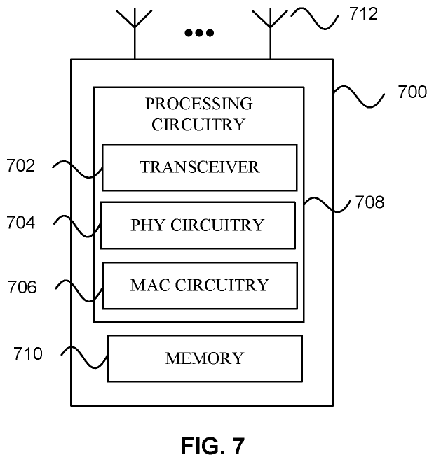

FIG. 7 illustrates a block diagram of an example wireless device 700 upon which any one or more of the techniques (e.g., methodologies or operations) discussed herein may perform. The wireless device 700 may be a HE device or HE wireless device. The wireless device 700 may be a HE STA 504, HE AP 502, and/or a HE STA or HE AP. A HE STA 504, HE AP 502, and/or a HE AP or HE STA may include some or all of the components shown in FIGS. 1-7. The wireless device 700 may be an example machine 600 as disclosed in conjunction with FIG. 6.

The wireless device 700 may include processing circuitry 708. The processing circuitry 708 may include a transceiver 702, physical layer circuitry (PHY circuitry) 704, and MAC layer circuitry (MAC circuitry) 706, one or more of which may enable transmission and reception of signals to and from other wireless devices 700 (e.g., HE AP 502, HE STA 504, and/or legacy devices 506) using one or more antennas 712. As an example, the PHY circuitry 704 may perform various encoding and decoding functions that may include formation of baseband signals for transmission and decoding of received signals. As another example, the transceiver 702 may perform various transmission and reception functions such as conversion of signals between a baseband range and a Radio Frequency (RF) range.

Accordingly, the PHY circuitry 704 and the transceiver 702 may be separate components or may be part of a combined component, e.g., processing circuitry 708. In addition, some of the described functionality related to transmission and reception of signals may be performed by a combination that may include one, any or all of the PHY circuitry 704 the transceiver 702, MAC circuitry 706, memory 710, and other components or layers. The MAC circuitry 706 may control access to the wireless medium. The wireless device 700 may also include memory 710 arranged to perform the operations described herein, e.g., some of the operations described herein may be performed by instructions stored in the memory 710.

The antennas 712 (some embodiments may include only one antenna) may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas 712 may be effectively separated to take advantage of spatial diversity and the different channel characteristics that may result.

One or more of the memory 710, the transceiver 702, the PHY circuitry 704, the MAC circuitry 706, the antennas 712, and/or the processing circuitry 708 may be coupled with one another. Moreover, although memory 710, the transceiver 702, the PHY circuitry 704, the MAC circuitry 706, the antennas 712 are illustrated as separate components, one or more of memory 710, the transceiver 702, the PHY circuitry 704, the MAC circuitry 706, the antennas 712 may be integrated in an electronic package or chip.

In some embodiments, the wireless device 700 may be a mobile device as described in conjunction with FIG. 6. In some embodiments the wireless device 700 may be configured to operate in accordance with one or more wireless communication standards as described herein (e.g., as described in conjunction with FIGS. 1-6, IEEE 802.11). In some embodiments, the wireless device 700 may include one or more of the components as described in conjunction with FIG. 6 (e.g., display device 610, input device 612, etc.) Although the wireless device 700 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

In some embodiments, an apparatus of or used by the wireless device 700 may include various components of the wireless device 700 as shown in FIG. 7 and/or components from FIGS. 1-6. Accordingly, techniques and operations described herein that refer to the wireless device 700 may be applicable to an apparatus for a wireless device 700 (e.g., HE AP 502 and/or HE STA 504), in some embodiments. In some embodiments, the wireless device 700 is configured to decode and/or encode signals, packets, and/or frames as described herein, e.g., PPDUs.

In some embodiments, the MAC circuitry 706 may be arranged to contend for a wireless medium during a contention period to receive control of the medium for a HE TXOP and encode or decode an HE PPDU. In some embodiments, the MAC circuitry 706 may be arranged to contend for the wireless medium based on channel contention settings, a transmitting power level, and a clear channel assessment level (e.g., an energy detect level).

The PHY circuitry 704 may be arranged to transmit signals in accordance with one or more communication standards described herein. For example, the PHY circuitry 704 may be configured to transmit a HE PPDU. The PHY circuitry 704 may include circuitry for modulation/demodulation, upconversion/downconversion, filtering, amplification, etc. In some embodiments, the processing circuitry 708 may include one or more processors. The processing circuitry 708 may be configured to perform functions based on instructions being stored in a RAM or ROM, or based on special purpose circuitry. The processing circuitry 708 may include a processor such as a general purpose processor or special purpose processor. The processing circuitry 708 may implement one or more functions associated with antennas 712, the transceiver 702, the PHY circuitry 704, the MAC circuitry 706, and/or the memory 710. In some embodiments, the processing circuitry 708 may be configured to perform one or more of the functions/operations and/or methods described herein.

In mmWave technology, communication between a station (e.g., the HE STAs 504 of FIG. 5 or wireless device 700) and an access point (e.g., the HE AP 502 of FIG. 5 or wireless device 700) may use associated effective wireless channels that are highly directionally dependent. To accommodate the directionality, beamforming techniques may be utilized to radiate energy in a certain direction with certain beamwidth to communicate between two devices. The directed propagation concentrates transmitted energy toward a target device in order to compensate for significant energy loss in the channel between the two communicating devices. Using directed transmission may extend the range of the millimeter-wave communication versus utilizing the same transmitted energy in omni-directional propagation.

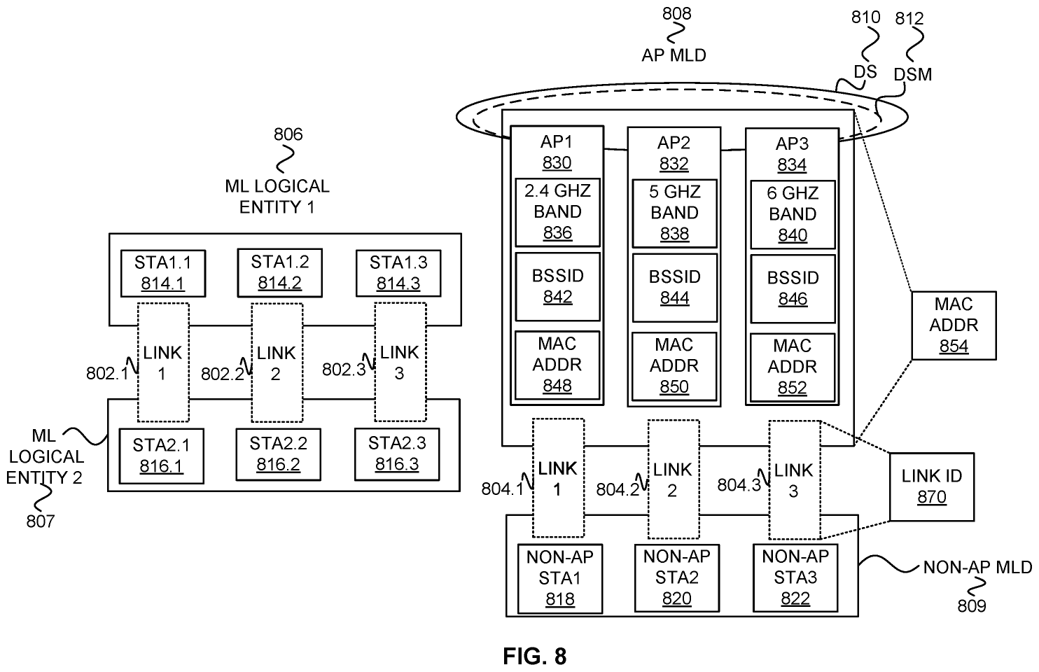

FIG. 8 illustrates multi-link devices (MLD) s 800, in accordance with some embodiments. Illustrated in FIG. 8 is ML logical entity 1 806, ML logical entity 2 807, AP MLD 808, and non-AP MLD 809. The ML logical entity 1 806 includes three STAs, STA1.1 814.1, STA1.2 814.2, and STA1.3 814.3 that operate in accordance with link 1 802.1, link 2 802.2, and link 3 802.3, respectively.

The Links are different frequency bands such as 2.4 GHz band, 5 GHz band, 6 GHZ band, and so forth. ML logical entity 2 807 includes STA2.1 816.1, STA2.2 816.2, and STA2.3 816.3 that operate in accordance with link 1 802.1, link 2 802.2, and link 3 802.3, respectively. In some embodiments ML logical entity 1 806 and ML logical entity 2 807 operate in accordance with a mesh network. Using three links enables the ML logical entity 1 806 and ML logical entity 2 807 to operate using a greater bandwidth and more reliably as they can switch to using a different link if there is interference or if one link is superior due to operating conditions.

The distribution system (DS) 810 indicates how communications are distributed and the DS medium (DSM) 812 indicates the medium that is used for the DS 810, which in this case is the wireless spectrum.

AP MLD 808 includes AP1 830, AP2 832, and AP3 834 operating on link 1 804.1, link 2 804.2, and link 3 804.3, respectively. AP MLD 808 includes a MAC ADDR 854 that may be used by applications to transmit and receive data across one or more of AP1 830, AP2 832, and AP3 834. Each link may have an associated link ID. For example, as illustrated, link 3 804.3 has a link ID 870.

AP1 830, AP2 832, and AP3 834 includes a frequency band, which are 2.4 GHz band 836, 5 GHz band 838, and 6 GHz band 840, respectively. AP1 830, AP2 832, and AP3 834 includes different BSSIDs, which are BSSID 842, BSSID 844, and BSSID 846, respectively. AP1 830, AP2 832, and AP3 834 includes different media access control (MAC) address (addr), which are MAC adder 848, MAC addr 850, and MAC addr 852, respectively. The AP 502 is a AP MLD 808, in accordance with some embodiments. The STA 504 is a non-AP MLD 809, in accordance with some embodiments.

The non-AP MLD 809 includes non-AP STA1 818, non-AP STA2 820, and non-AP STA3 822. Each of the non-AP STAs may have MAC addresses and the non-AP MLD 809 may have a MAC address that is different and used by application programs where the data traffic is split up among non-AP STA1 818, non-AP STA2 820, and non-AP STA3 822.

The STA 504 is a non-AP STA1 818, non-AP STA2 820, or non-AP STA3 822, in accordance with some embodiments. The non-AP STA1 818, non-AP STA2 820, and non-AP STA3 822 may operate as if they are associated with a BSS of AP1 830, AP2 832, or AP3 834, respectively, over link 1 804.1, link 2 804.2, and link 3 804.3, respectively.

A Multi-link device such as ML logical entity 1 806 or ML logical entity 2 807, is a logical entity that contains one or more STAs 814, 816. The ML logical entity 1 806 and ML logical entity 2 807 each has one MAC data service interface and primitives to the logical link control (LLC) and a single address associated with the interface, which can be used to communicate on the DSM 812. Multi-link logical entity allows STAs 814, 816 within the multi-link logical entity to have the same MAC address. In some embodiments a same MAC address is used for application layers and a different MAC address is used per link.

In infrastructure framework, AP MLD 808, includes APs 830, 832, 834, on one side, and non-AP MLD 809, which includes non-APs STAs 818, 820, 822 on the other side.

ML AP device (AP MLD): is a ML logical entity, where each STA within the multi-link logical entity is an EHT AP 502, in accordance with some embodiments. ML non-AP device (non-AP MLD) A multi-link logical entity, where each STA within the multi-link logical entity is a non-AP EHT STA 504. AP1 830, AP2 832, and AP3 834 may be operating on different bands and there may be fewer or more APs. There may be fewer or more STAs as part of the non-AP MLD 809.

In some embodiments the AP MLD 808 is termed an AP MLD or MLD. In some embodiments non-AP MLD 809 is termed a MLD or a non-AP MLD. Each AP (e.g., AP1 830, AP2 832, and AP3 834) of the MLD sends a beacon frame that includes: a description of its capabilities, operation elements, a basic description of the other AP of the same MLD that are collocated, which may be a report in a Reduced Neighbor Report element or another element such as a basic multi-link element. AP1 830, AP2 832, and AP3 834 transmitting information about the other APs in beacons and probe response frames enables STAs of non-AP MLDs to discover the APs of the AP MLD.

In a Wi-Fi network or IEEE 802.11 network, “channel switching” refers to a method where the AP 502 in an infrastructure networks or Group Owner (GO) in peer-to-peer networks determines to transition from a current channel to a new target channel. The AP 502 may determine to switch channels for lots of reasons such as interference.

During channel switching, the clients such as STAs 504 and legacy devices 506 that are associated with the AP 502 on an old channel or original channel often remain associated with the AP 502 on the new channel. The clients are expected to move alongside the GO or AP 502 and maintain uninterrupted communication as if they were still operating on the original channel. The continues uninterrupted communication includes preserving sequence numbers of PPDUs and other relevant contexts.

However, Wi-Fi or IEEE 802.11 bands do not uniformly follow the same rules in terms of the allowed formats and bandwidths that clients can use. For example, in the 2.4 GHz band, a client can utilize the HT format with a bandwidth of 20/40 MHz. In the 5 GHz band, a client can use HT/VHT and HE formats with bandwidths of 20/40/80/160 MHz. In the 6 GHz band, a client is mandated to use HE or EHT (Wi-Fi-7) and can transmit frames using a 320 MHZ bandwidth.

Clients associate with APs 502. During the association process, the clients and APs 502 exchange capabilities through an association request frame and an association response frame. The AP 502 may move to another band or target channel and the AP 502 does not know the capabilities of its clients in the target channel. The AP 502 uses the lowest common denominator of client capabilities to communicate with the clients on the target channel, which may be using an HT format, which, often, fails to fully exploit the enhanced potential of the new target band.

A technical problem is how to use a client's full capabilities as soon as the AP 502 switches to the target channel to improve the utilization of the target channel and communications with the client. The technical challenge is addressed in some embodiments by the AP 502 exchanging capabilities information with the clients in the target channel through a reassociation method after the AP switches to the target channel. The AP can accurately determine the client's capabilities in the target channel and effectively utilize the enhanced band capabilities.

In some embodiments, reassociation is not used because it is a time-consuming process and thus may contradicts an objective of the channel switch, which is to be efficient and seamless from the user's perspective. A reassociation processes may cause delay for the user of a client device. Additionally, reassociation often necessitates user intervention and involves the regeneration of security keys and data path context, including sequence numbers. These additional steps introduce delays and interruptions in the communication process, which can be disruptive and undesirable for users.

Some embodiments introduce a protocol for the Wi-Fi clients, either peer-to-peer or infrastructure, to communicate their capabilities to the AP 502 before the switch to the target channel. By doing so, after the AP 502 switches to the target channel, the AP 502 is aware of the capabilities of its clients in the target channel, and thus can utilize the full benefit of the target channel. The communications of the client's capabilities is done via a channel usage request frame, in accordance with some embodiments.

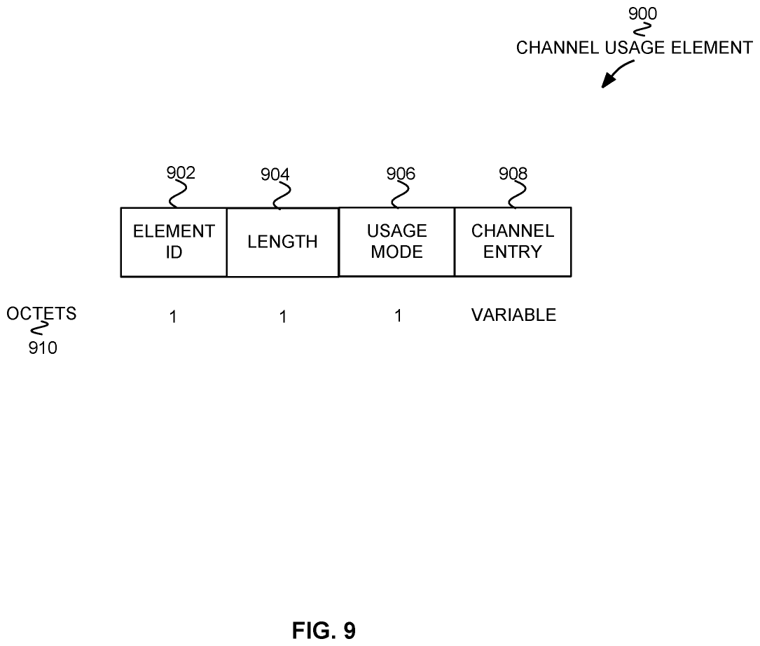

FIG. 9 illustrates a channel usage element 900, in accordance with some embodiments. The channel usage element 900 includes an element identification (ID) 902 subfield that identifies the channel usage element 900. The length 904 subfield identifies the length of the channel usage element 900.

The usage mode 906 field is a number that identifies the usage of the recommended channels listed in the Operating Class/Channel Number pair fields. The Usage Mode definitions are shown in Table 9-266 (Usage Mode definitions).

TABLE 1
Usage Mode definitions

| Value | Usage Mode |
|---|---|
| 0 | Noninfrastructure BSS |
| 1 | Off-channel TDLS direct link |
| 2 | Noninfrastructure BSS in which none of the APs |
| | belonging to the same ESS operate on the |
| | channels identified by the Channel Entry field |
| 3 | Peer-to-peer link indication |
| 4 | Noninfrastructure BSS channel switch request |
| <TBT> | Capability notification; TBT may be a constant |
| | from 5 to 255. |
| <TBT> + 1-254 | Reserved |
| 255 | Unknown request |

Where to be determined (TBT) indicates that the value to indicate capability notification may be a value from 5 to 244. The octets 910 indicates the length of the fields. The channel entry 908 field indicates includes zero or more Operating Class and Channel fields. The format of the Operating Class and Channel fields is defined in the IEEE 802.11 communications standard. Operating Class and Channel fields can be grouped together to identify a noncontiguous channel as described therein.

The Operating Class and Channel field is used in the Location Indication Channels subelement of the Location Parameters element and in the Channel Usage element. The Operating Class and Channel field indicates an operating class and channel. The format of the field is defined in the IEEE 802.11 communications standard. The Operating Class field indicates an operating class value as defined in IEEE 802.11 communications standard. The operating class is interpreted in the context of the country specified in the Beacon frame. The Channel field indicates a channel number, which is interpreted in the context of the indicated operating class.

Channel numbers are defined in the IEEE 802.11 communications standard. The channel usage element 900 field includes one or more Channel Usage elements described to identify the request channel usage. If the Usage Mode field in a Channel Usage element indicates Non-infrastructure BSS channel switch request or Capability notification, no other Channel Usage element is included in the Channel Usage Request frame.

The channel usage element 900 can be included in Probe Request frames, Probe Response frames, Channel Usage Request frames, and Channel Usage Response frames.

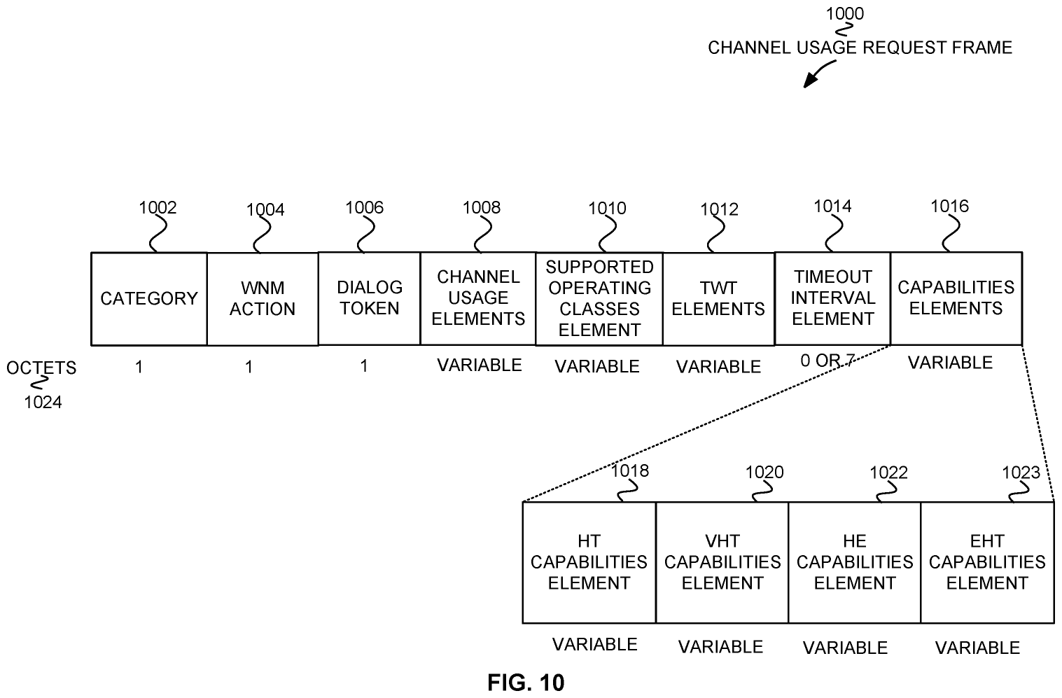

FIG. 10 illustrates a channel usage request frame 1000, in accordance with some embodiments. The Category 1002 field, the wireless network management (WNM) Action 1004 field, and the Dialog Token 1006 field are defined in the IEEE 802.11 standard. The octets 1024 indicates a length of the fields.

The Channel Usage Element 1008 field includes one or more channel usage elements 900 to identify the request channel usage. If the usage mode 906 field in a channel usage element 900 indicates Non-infrastructure BSS channel switch request or Capability notification (as described in Table 1, which may be referred to as Table 9-266), no other Channel Usage clement is included in the Channel Usage Request frame.

The Supported Operating Classes Element 1010 field contains a Supported Operating Classes element to indicate the supported operating classes for the requested network type, consistent with the Country element advertised by the AP 502. The Supported Operating Classes is described in IEEE 802.11. This field is not present if the Usage Mode field in the Channel Usage element is Capability notification.

The Supported Operating Classes Element 1010 field contains a Supported Operating Classes element to indicate the supported operating classes for the requested network type, consistent with the Country element advertised by the AP. The Supported Operating Classes is described in the IEEE 802.11 communications standard. This field is not present if the Usage Mode field in the Channel Usage element is Capability notification.

The target wake time (TWT) Elements 1012 field includes zero or more TWT elements each containing only one individual TWT parameter set as described in the IEEE 802.11 communication standard. The Timeout Interval Element 1014 field is present when the TWT Elements field contains at least one TWT element. Otherwise, the Timeout Interval Element field is not present in this frame.

The IEEE 802.11 communication standards are referred to by the following terms high-throughput (HT), very-high throughput (VHT), high-efficiency (HE), and extremely high throughput (EHT).

The capabilities elements 1016 includes zero or more of the HT capabilities element 1018, the VHT capabilities element 1020, the HE capabilities element 1022, and the EHT capabilities clement 1023.

The HT capabilities element 1018 field, if present, contains an HT Capabilities element. It specifies the HT capabilities of the STA 504 in the operating class and channel specified in the channel entry 908 field of the channel usage element 900. It is optionally present when the usage mode 906 field in the channel usage clement 900 indicates Non-infrastructure BSS channel switch request or Capability notification and is not present otherwise, in accordance with some embodiments.

The VHT capabilities element 1020 field, if present, contains a VHT Capabilities clement. It specifies the VHT capabilities of the STA 504 for the operating class and channel specified in the channel entry 908 field of the channel usage element 900. It is optionally present when the usage mode 906 field in the channel usage clement 900 indicates Non-infrastructure BSS channel switch request or Capability notification as discussed in Table 1, and otherwise is not present, in accordance with some embodiments.

The HE capabilities element 1022 field, if present, contains an HE Capabilities element. It specifies the HE capabilities of the STA 504 for the operating class and channel specified in the channel entry 908 field of the channel usage element 900. It is optionally present when the usage mode 906 field in the channel usage element 900 indicates Non-infrastructure BSS channel switch request or Capability notification as discussed in Table 1 and otherwise is not present, in accordance with some embodiments.

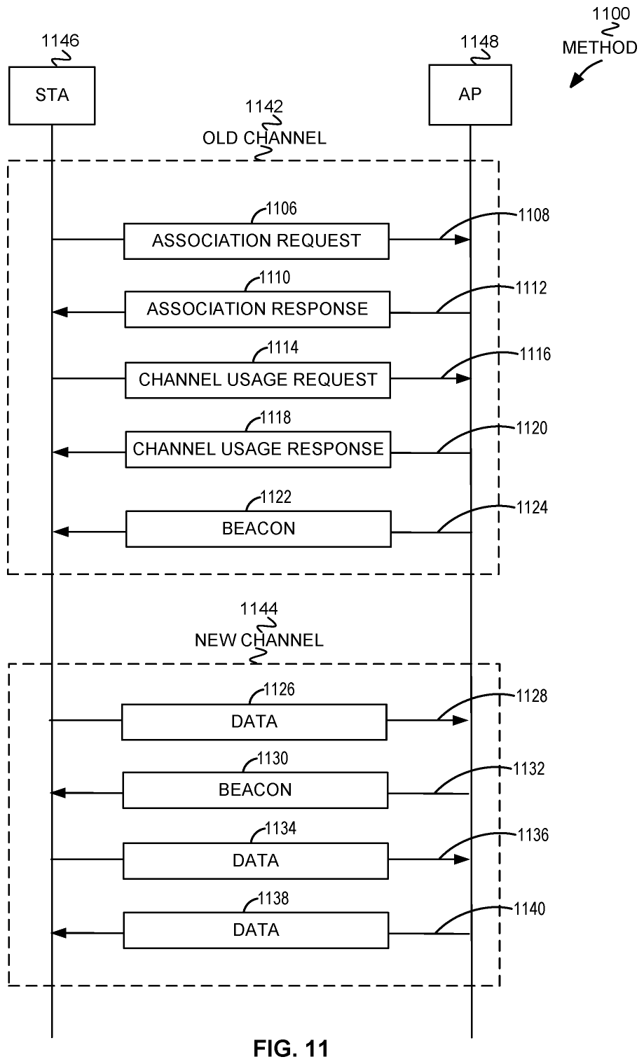

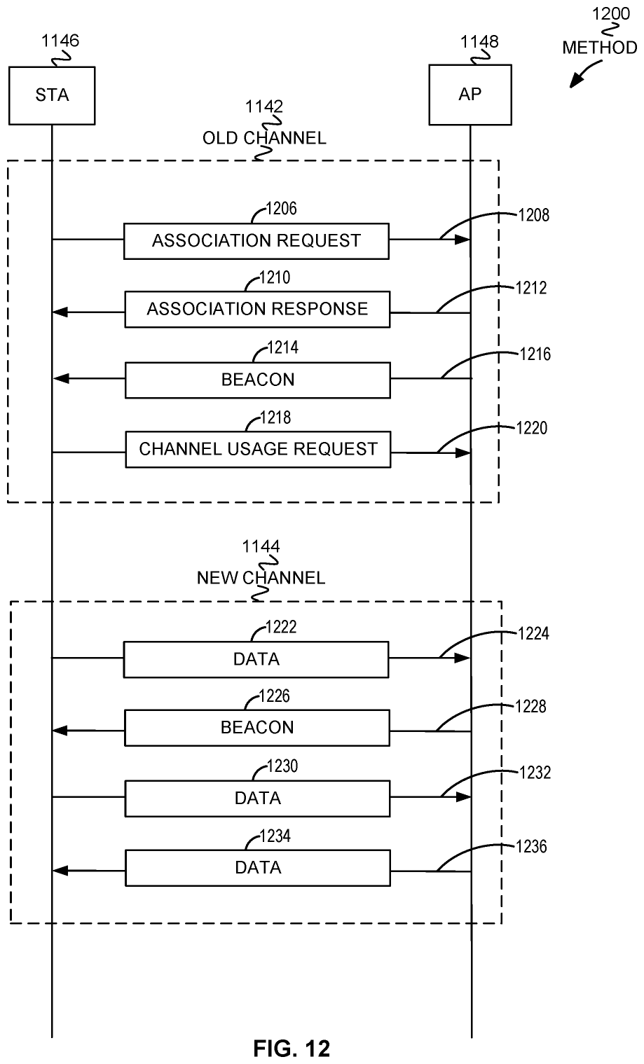

FIG. 11 illustrates a method 1100 for updating capabilities before channel switch, in accordance with some embodiments. In some embodiments, the STA 504 can communicate its capabilities in the target channel in two different ways exemplified by FIGS. 11 and 12. The STA 1146 is a STA 504, an AP, non-AP STA, or non-AP STA of the non-AP MLD, in accordance with some embodiments. The AP 1148 is an AP 502, GO, STA 504 acting as an AP, or an AP of an AP MLD 808, in accordance with some embodiments. In FIG. 11, the STA 1146 initiates a channel switch.

The method 1100 begins at operation 1108 with the STA 1146 sending to the AP 1148 an association request 1106. The association request 1106 is transmitted on the old channel 1142, which is a frequency range on a band where the band is 2.4 GHZ, 5 GHZ, 6 GHZ, or another band. The association request 1106 includes one or more capabilities elements 1016 where the capabilities element 1016 are dependent on at least the band and the country, which may have been received by a previous frame such as a beacon frame from the AP 502.

The method 1100 continues at operation 1112 with the AP 1148 sending an association response 1110 to the STA 1146. The association request 1106 and association response 1110 may be in accordance with the IEEE 802.11 communication standard where capabilities of the STA 1146 and AP 1148 as well as channel information is exchanged.

The method 1100 optionally continues at operation 1116 where the STA 1146 sends to the AP 1148 a channel usage request 1114 frame in which the STA 1146 requests the AP 502 to move to a target channel that may be in a different band than the current channel and is specified in the channel entry 908, in accordance with some embodiments. The channel usage request 1114 is a channel usage request frame 1000, in accordance with some embodiments.

The channel usage request 1114 includes the channel usage element 900 with usage mode=4 (Non-infrastructure BSS channel switch request) and appends its target channel capabilities in the capabilities elements 1016 field such as including an HE capabilities element 1022. If the STA 1146 provides multiple channels/bands as preferred channels to switch, the corresponding multiple capabilities elements 1016 are included in the channel usage element 900 or channel switch request frame.

In some embodiments, the AP 502 may decide not to move to the target channel, so in this case the method 1100 does not result in a channel switch. The decision whether to move to the target channel is determined by the AP/GO. The STA 504 may only propose a switch but not force such a switch, in accordance with some embodiments. The method 1100 may end or the AP 502 may send a frame indicating a rejection of the channel usage request 1114, which may be included in the channel usage response 1118. In some embodiments, the channel usage request 1114 includes no channel information, which may indicate rejection of the request.

Prior to operation 1116, the STA 1146 received a beacon frame from the AP 1148, which indicated the AP 1148 supports reception of a channel usage request frame 1000. Additionally, the STA 1146 may have included an indication in the associate request 1106 frame or another frame a support of the channel usage request frame 1000. The following indicates a field in a beacon frame or another frame sent by the STA 1146 and/or AP 1148.

| | | |
|---|---|---|
| TBT | Capability | Set to 1 to indicate the AP supports reception of a |
| | Notification | Channel Usage Request frame that includes |
| | Support | capabilities elements. Set to 0 otherwise. |
| | | This field is reserved for a non-AP STA. |

The method 1100 continues at operation 1120 with the AP 1148 sending a channel usage response 1118 frame to the STA 1146. The channel usage response 1118 may include the channels information indicates the band and channel for the switch to the target channel.

The method 1100 continues at operation 1124 with the AP 1148 transmitting a beacon 1122 frame to the STA 1146 and other STAs that may be associated with the AP 1148. The beacon 1122 frame may include a channel switch announcement (CSA) eCSA+CSA, an indication of the country, a wide band element, transmit (TX) envelop, BW indicator, EHT capabilities, EHT information, and so forth. cCSA+CSA notify the STA 1146 and other STAs 1146 about the imminent channel switch to the new channel 1144. The beacon 1122 may be configured to include information as discussed in the IEEE 802.11 communications standard.

As an example, the association request 1106 may include an HT capabilities element 1018 frame to operate on the old channel 1142 using HT. The association response 1110 frame may include HT capabilities and HT information of the AP 1148 and/or for the STA 1146 to use for operation. The channel usage request 1114 may include a EHT capabilities element 1020 indicating the VHT capabilities of the STA 1146 to operate on the new channel 1144 indicated in the channel usage request 1114.

The method 1100 continues at operation 1128 with the STA 1146 transmitting data 1126 to the AP 1148, which is transmitted in accordance with the VHT capabilities of the STA 1146 and the information included in the beacon 1122. The STA 1146 can immediately use the new channel 1144 with the new capabilities without a delay in communicating or reassociating with the AP 1148.

The method 1100 continues at operation 1132 with the AP 1148 transmitting a beacon 1130 frame, which may include information such as the VHT capabilities of the AP 1148. The beacon 1130 frame enables any other STAs 504 operating on the new channel 1144 to be notified of the AP 1148. The method 1100 continues with operation 1136 and operation 1140 where the STA 1146 send data 1134 and the AP 1148 sends data 1138 in accordance with VHT capabilities, which may have been modified in the beacon 1130 frame from the VHT capabilities used for the STA 1146 to transmit the data 1126 to the AP 1148 in operation 1128.

The method 1100 may be performed by an apparatus for a STA 504, an apparatus of a non-AP MLD 809, an apparatus of an AP 502, or an apparatus of an AP MLD 808, and/or another device or apparatus disclosed herein. The method 1100 may include one or more additional instructions. The method 1100 may be performed in a different order. One or more of the operations of method 1100 may be optional.

FIG. 12 illustrates a method 1200 for updating capabilities before channel switch, in accordance with some embodiments. The AP 502 initiates a channel switch in method 1200.

The method 1200 begins, in which it adds a CSA/E-CSA in its beacon, notifying the STAs 504 about imminent channel switch. In this case, in the time between the advertisement in the beacon and the actual channel switch, the client sends its target channel capabilities via a channel usage frame with usage mode=5 (Capability information)

The method 1200 begins at operation 1208 with the STA 1146 sending to the AP 1148 an association request 1206. The association request 1106 is transmitted on the old channel 1142, which is a frequency range on a band where the band is 2.4 GHZ, 5 GHZ, 6 GHZ, or another band. The association request 1106 includes one or more capabilities elements 1016 where the capabilities element 1016 are dependent on at least the band and the country, which may have been received by a previous frame such as a beacon frame from the AP 502.

The method 1200 continues at operation 1212 with the AP 1148 sending an association response 1210 to the STA 1146. The association request 1206 and response 1210 may be in accordance with the IEEE 802.11 communication standard where capabilities of the STA 1146 and AP 1148 as well as channel information is exchanged.

The method 1200 continues at operation 1216 with the AP 1148 transmitting a beacon 1214 frame to the STA 1146 and other STAs that may be associated with the AP 1148. The beacon 1214 frame includes an CSA+CSA, an indication of the country, a wide band clement, transmit (TX) envelop, BW indicator, EHT capabilities clement 1023, EHT information, and so forth. cCSA+CSA notifies the STA 1146 and other STAs 1146 about the imminent channel switch to the new channel 1144. The beacon 1122 may be configured to include information as discussed in the IEEE 802.11 communications standard. Other or different capabilities than the EHT capabilities clement 1023 may be included in the beacon 1214.

The method 1200 continues at operation 1220 with the STA 1146 transmitting or sending the channel usage request 1218 frame to the AP 1148. The STA 1146 determines the AP 1148 is imminently moving to the new channel 1144 and sends the channel usage request 1218 with EHT capabilities element 1023 (and/or other capabilities) to the AP 1148 on the old channel 1142 before the AP 1148 switches to the new channel 1144. The usage mode 906 of the channel usage element 900 included in the channel usage request 1218 frame indicates capability information, which may be a 5. In accordance with some embodiments, the STA 1146 waits a random delay uniformly distributed in the range between 0 and 5000 μs before transmitting or gaining access to the old channel 1142.

The method 1200 continues at operation 1224 with the STA 1146 transmitting data 1222 to the AP 1148, which is transmitted in accordance with the EHT capabilities of the STA 1146 and the information included in the beacon 1214. The STA 1146 can immediately after detecting or decoding the beacon in the new channel use the new channel 1144 with the new capabilities, which here are EHT, without a delay in communicating or reassociating with the AP 1148.

The method 1200 continues at operation 1228 with the AP 1148 transmitting a beacon 1226 frame, which may include information such as the EHT capabilities clement 1023 of the AP 1148. The beacon 1226 frame enables any other STAs 504 operating on the new channel 1144 to be notified of the AP 1148. The method 1200 continues with operation 1232 and operation 1236 where the STA 1146 sends data 1230 to the AP 1148, and the AP 1148 sends data 1234 to the STA 1146 in accordance with EHT capabilities, which may have been modified in the beacon 1226 frame from the EHT capabilities used for the STA 1146 to transmit the data 1222 to the AP 1148 in operation 1224.

The method 1200 may be performed by an apparatus for a STA 504, an apparatus of a non-AP MLD 809, an apparatus of an AP 502, or an apparatus of an AP MLD 808, and/or another device or apparatus disclosed herein. The method 1200 may include one or more additional instructions. The method 1200 may be performed in a different order. One or more of the operations of method 1200 may be optional.

A non-AP STA that is operating in a noninfrastructure BSS may send a Channel Usage Request frame with a Channel Usage element that carries a Usage Mode field indicating Noninfrastructure BSS channel switch request to a peer STA to indicate that it prefers to switch the operating channel of the noninfrastructure BSS to another channel. A non-AP STA may indicate the preferred operating channels by including one or more Operating class and Channel fields in the Channel Entry field of the Channel Usage element carried in the corresponding Channel Usage Request frame. To provide the parameters in the HT Capabilities clement, VHT Capabilities element and/or HE Capabilities element for the preferred operating channel, the non-AP STA shall include the corresponding capabilities clement(s) in the Channel Usage Request frame; otherwise, capabilities element(s) will not be included. When the Usage Mode field indicates Non-infrastructure BSS channel switch request and any capabilities elements are included in the Channel Usage Request frame, the Channel Entry field shall include an Operating Class and Channel field that indicates the operating class and channel that the capability notification applies to.

Upon receiving a Channel Usage Request frame with a Channel Usage element that carries a Usage Mode field indicating Non-infrastructure BSS channel switch request, a STA that supports non-infrastructure BSS channel switch requests and is operating in a non-infrastructure BSS should consider switching the operating channel of the non-infrastructure BSS to a new channel that is one of the preferred channels indicated in the received Channel Entry field of the Channel Usage element, if present. The STA shall transmit a Channel Usage Response frame in response to the reception of a Channel Usage Request frame with the Usage Mode field equal to 4 that includes a Channel Usage element with the Usage Mode field set to 4. If the channel switch request is accepted, the STA shall include the target operating class and channel in the Channel Entry field of the Channel Usage clement in the Channel Usage Response frame. Otherwise, no Channel Entry field shall be included. When the Channel Usage clement is carried in a Probe Request or Probe Response frame, the Usage Mode field shall not be set to 4.

An AP that has dot 11ChannelUsageActivated equal to true and supports capability notification shall set the Capability Notification Support field to 1 in the Extended Capabilities elements that it transmits.

If an AP has the Capability Notification Support field set to 1 in the Extended Capabilities clement, an associated non-AP STA may send a Channel Usage Request frame with the Usage Mode field indicating Capability notification in the Channel Usage clement to the AP after the non-AP STA receives an Extended Channel Switch Announcement element from the AP. The HT Capabilities clement, VHT Capabilities element and/or HE Capabilities element shall be included in the Channel Usage Request frame with the Usage Mode field indicating Capability notification in the Channel Usage element to provide corresponding capabilities element(s) for the new operating class and channel; otherwise, capabilities element(s) shall not be included. When the Usage Mode field indicates Capability notification, the Channel Entry field shall include an Operating Class and Channel field that indicates the operating class and channel that the capability notification applies to.

When an associated non-AP STA chooses to send a Channel Usage Request frame with the Usage Mode field indicating Capability notification in the Channel Usage element to the AP, the STA shall wait a random delay uniformly distributed in the range between 0 and 5000 μs, and then transmit the Channel Usage Request frame once any applicable conditions for transmitting are met (e.g., channel access procedures, DFS or enablement procedures).

The Channel Usage Request frame indicating Capability notification might be transmitted before or after a channel switch. In either case, the Operating Class and Channel field unambiguously identifies the channel for which the notification applies.

If an AP doesn't have the Capability Notification Support field set to 1 in the Extended Capabilities element, an associated non-AP STA shall not send a Channel Usage Request frame with the Usage Mode field indicating Capability notification in the Channel Usage element to the AP.

When the Channel Usage element is carried in a Probe Request or Probe Response frame, the Usage Mode field shall not indicate Noninfrastructure BSS channel switch request or Capability notification.

In some embodiments, a STA 504 for which dot11 VHTOption Implemented is true shall set dot11HighThroughput OptionImplemented to true. A STA operating in the 2.4 GHZ band that sets dot11 HEOptionImplemented to true shall set dot11High ThroughputOptionImplemented to true. A STA operating in the 5 GHz or 6 GHZ band that sets dot11 HEOptionImplemented to true shall set both dot11VHTOptionImplemented and dot11HighThroughputOptionImplemented to true. If dotxxxOptionImplemented is true, the xxx Capabilities element is included in the Association Request/Response frame where xxx is discussed below.

If an HE STA 504 operates in 2.4 GHz, it shall include HT/HE Capabilities elements in the Association Request/Response frame, but do not have VHT Capabilities element of its peer device. If an HE STA 504 operates in 5 GHz or 6 GHz, it shall include all HT/VHT/HE Capabilities elements in the Association Request/Response frame.

However, even though the HT or HE Capabilities element are always included in the Association Request/Response frames, the parameters of HT or HE Capabilities clement may have different configurations for different bands. For example, STA may not support 40 MHZ on 2.4 GHz band but support 40 MHz for 5 GHz band. 40 MHz related fields in the HT Capabilities element may be configured differently with different band. The physical layer (PHY) packet extension (PPE) Thresholds field of the HE Capabilities element might be different between bands.

In some embodiments, the capabilities elements need to be communicated from STA 504 to AP 502 when switching bands as follows. VHT Capabilities element when switching from 2.4 GHz band to 5 GHz band (because it was not included in the original association frames). HT or HE Capabilities element when switching between bands (because they might have different configurations.)

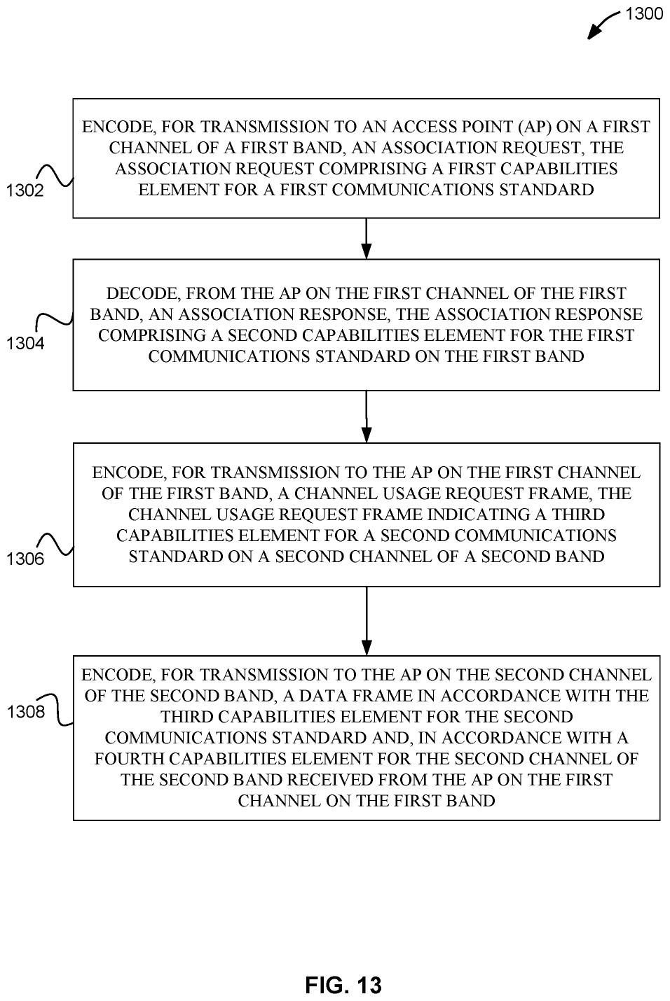

FIG. 13 illustrates a method 1300 for updating capabilities before channel switch, in accordance with some embodiments. The method 1300 begins at operation 1302 with encoding, for transmission to an access point (AP) on a first channel of a first band, an association request, the association request comprising a first capabilities element for a first communications standard. For example, the STA 1146 in FIGS. 11 and 12 encodes the association request 1106 frame and the association request 1206, respectively.

The method 1300 continues at operation 1304 with decoding, from the AP on the first channel of the first band, an association response, the association response comprising a second capabilities element for the first communications standard on the first band. For example, the STA 1146 in FIGS. 11 and 12 decodes from the AP 1148 the association response 1110 frame and association resposne 1210 frame, respectively.

The method 1300 continues at operation 1306 with encoding, for transmission to the AP on the first channel of the first band, a channel usage request frame, the channel usage request frame indicating a third capabilities element for a second communications standard on a second channel of a second band. For example, the STA 1146 in FIGS. 11 and 12 encodes the channel usage request 1114 frame and the channel usage request 1218 frame, respectively.

The method 1300 continues at operation 1308 with encoding, for transmission to the AP on the second channel of the second band, a data frame in accordance with the third capabilities element for the second communications standard and, in accordance with a fourth capabilities element for the second channel of the second band received from the AP on the first channel on the first band. For example, the STA 1146 in FIGS. 11 and 12 encodes data 1126 frame and data 1222 frame, respectively, for transmission to the AP 1148.

The method 1300 may be performed by an apparatus for a STA 504, an apparatus of a non-AP MLD 809, an apparatus of an AP 502, or an apparatus of an AP MLD 808, and/or another device or apparatus disclosed herein. The method 1300 may include one or more additional instructions. The method 1300 may be performed in a different order. One or more of the operations of method 1300 may be optional.

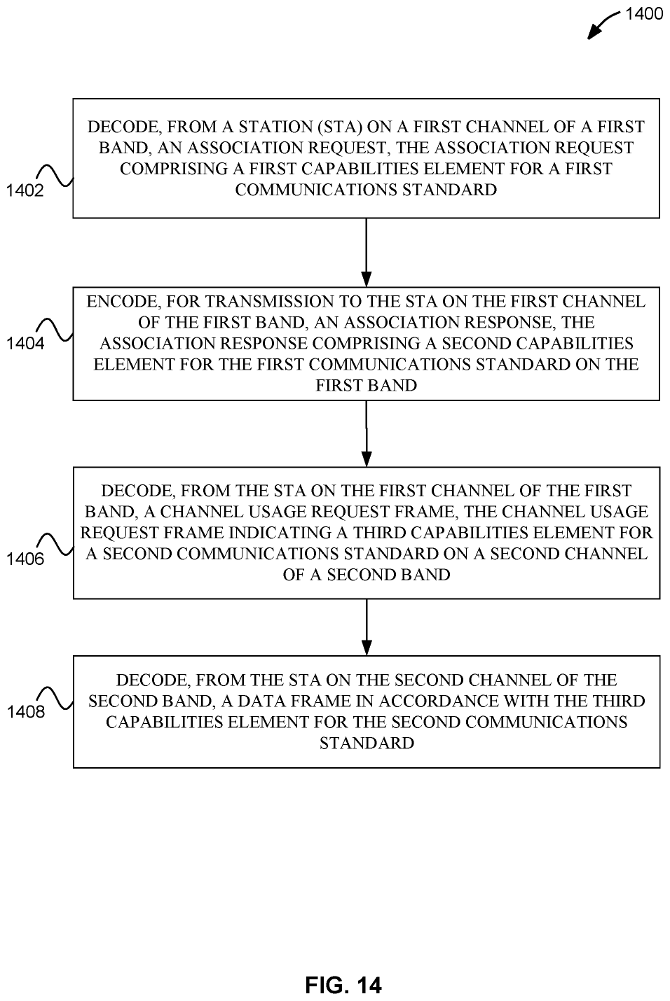

FIG. 14 illustrates a method 1400 for updating capabilities before channel switch, in accordance with some embodiments. The method begins at operation 1402 with decode, from a station (STA) on a first channel of a first band, an association request, the association request comprising a first capabilities element for a first communications standard. For example, the AP 1148 of FIGS. 11 and 12 decodes from the STA 1146 the association request 1106 frame and the association request 1206 frame, respectively.

The method 1400 continues at operation 1404 with encoding, for transmission to the STA on the first channel of the first band, an association response, the association response comprising a second capabilities element for the first communications standard on the first band. For example, the AP 1148 of FIGS. 11 and 12 encodes for the STA 1146 the association response 1110 frame and the association response 1210 frame, respectively.

The method 1400 continues at operation 1406 with decoding, from the STA on the first channel of the first band, a channel usage request frame, the channel usage request frame indicating a third capabilities element for a second communications standard on a second channel of a second band. For example, the AP 1148 of FIGS. 11 and 12 decodes from the STA 1146 channel usage response 1118 and channel usage request 1218, respectively.

The method 1400 continues at operation 1408 with decoding, from the STA on the second channel of the second band, a data frame in accordance with the third capabilities element for the second communications standard. For example, the AP 1148 of FIGS. 11 and 12 decodes from the STA 1146 data 1126 frame and data 1222 frame, respectively.

The method 1400 may be performed by an apparatus for a STA 504, an apparatus of a non-AP MLD 809, an apparatus of an AP 502, or an apparatus of an AP MLD 808, and/or another device or apparatus disclosed herein. The method 1400 may include one or more additional instructions. The method 1400 may be performed in a different order. One or more of the operations of method 1400 may be optional.

The Abstract is provided to comply with 37 C.F.R. Section 1.72 (b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus for a station (STA), the apparatus comprising memory;
and processing circuitry coupled to the memory, the processing circuitry configured to:
encode, for transmission to an access point (AP) on a first channel of a first band, an association request, the association request comprising a first capabilities element for a first communications standard;
decode, from the AP on the first channel of the first band, an association response, the association response comprising a second capabilities element for the first communications standard on the first band;
encode, for transmission to the AP on the first channel of the first band, a channel usage request frame, the channel usage request frame indicating a third capabilities element for a second communications standard on a second channel of a second band; and
encode, for transmission to the AP on the second channel of the second band, a data frame in accordance with the third capabilities element for the second communications standard and, in accordance with a fourth capabilities element for the second channel of the second band received from the AP on the first channel on the first band.

2. The apparatus of claim 1, wherein the processing circuitry is further configured to: before the encode, for transmission to the AP, on the second channel of the second band and after the encode, for transmission to the AP on the first channel of the first band the channel usage request frame:
decode, from the AP, a beacon frame, the beacon frame comprising an indication of the second channel of the second band and the fourth capabilities element for the second channel of the second band.

3. The apparatus of claim 1, wherein the processing circuitry is further configured to: before the encode, for transmission to the AP on the first channel of the first band the channel usage request frame:
decode, from the AP, a beacon frame, the beacon frame comprising an indication of the second channel of the second band, the fourth capabilities element for the second channel of the second band, and a channel switch announcement (CSA), the CSA indicating the second channel of the second band.

4. The apparatus of claim 3, wherein the channel usage request frame comprises a channel usage element, the channel usage element comprising a usage mode field, the usage mode field indicating a capability notification.

5. The apparatus of claim 1, wherein the channel usage request frame comprises a channel usage element, the channel usage element indicating a non-infrastructure basic service set (BSS) switch request or a capabilities notification.

6. The apparatus of claim 1, wherein the first band and the second band are each one of: a 2.4 GHz band, a 5 GHz band, and a 6 GHz band.

7. The apparatus of claim 1, wherein the processing circuitry is further configured to:
refrain transmitting the third capabilities element on the second channel of the second band before the encode, for transmission to the AP, on the second channel of the second band, data frame.

8. The apparatus of claim 7, wherein the processing circuitry is further configured to:
decode, from the AP on the second channel of the second band, another data frame.

9. The apparatus of claim 1, wherein the first communications standard and the second communications standard are a same communications standard.

10. The apparatus of claim 1, wherein the first communications standard and the second communications standard are each at least one of: high-throughput (HT) communications standard, very-high throughput (VHT) communications standard, a high efficiency (HE) communications standard, or an extremely high-efficiency (EHT) communications standard.

11. The apparatus of claim 1, wherein the first communications standard and the second communications standard are a same communication standard, and wherein the first capabilities element for the first channel of the first band is different than the third capabilities element for the second channel of the second band.

12. The apparatus of claim 1, wherein the processing circuitry is further configured to: before the encode, for transmission to the AP on the first channel of the first band, the association request, decode, from the AP on the first channel of the first band, a beacon frame, the beacon frame comprising a capability notification support field, the capability notification support field indicating support for the channel usage request frame.

13. The apparatus of claim 1, wherein the STA is affiliated with a non-access point (AP) multi-link device (MLD) and the access point is affiliated with an AP MLD.

14. The apparatus of claim 1, further comprising transceiver circuitry coupled to the processing circuitry, wherein the transceiver circuitry is coupled to two or more microstrip antennas for receiving signaling in accordance with a multiple-input multiple-output (MIMO) technique, or the transceiver circuitry is coupled to the processing circuitry, the transceiver circuitry coupled to two or more patch antennas for receiving signaling in accordance with a multiple-input multiple-output (MIMO) technique.

15. A non-transitory computer-readable storage medium including instructions that, when processed by one or more processors, configure an apparatus of a station (STA) to perform operations comprising:
encode, for transmission to an access point (AP) on a first channel of a first band, an association request, the association request comprising a first capabilities element for a first communications standard;
decode, from the AP on the first channel of the first band, an association response, the association response comprising a second capabilities element for the first communications standard on the first band;
encode, for transmission to the AP on the first channel of the first band, a channel usage request frame, the channel usage request frame indicating a third capabilities element for a second communications standard on a second channel of a second band; and
encode, for transmission to the AP, on the second channel of the second band, a data frame in accordance with the third capabilities element for the second communications standard and, in accordance with a fourth capabilities element for the second channel of the second band received from the AP on the first channel on the first band.

16. The non-transitory computer-readable storage medium of claim 15, wherein the operations further comprise:
before the encode, for transmission to the AP, on the second channel of the second band and after the encode, for transmission to the AP on the first channel of the first band the channel usage request frame:
decode, from the AP, a beacon frame, the beacon frame comprising an indication of the second channel of the second band and the fourth capabilities element for the second channel of the second band.

17. The non-transitory computer-readable storage medium of claim 15, wherein the operations further comprise:
before the encode, for transmission to the AP on the first channel of the first band the channel usage request frame:
decode, from the AP, a beacon frame, the beacon frame comprising an indication of the second channel of the second band, the fourth capabilities element for the second channel of the second band, and a channel switch announcement (CSA), the CSA indicating the second channel of the second band.

18. An apparatus for an access point (AP), the apparatus comprising memory; and processing circuitry coupled to the memory, the processing circuitry configured to:
decode, from a station (STA) on a first channel of a first band, an association request, the association request comprising a first capabilities element for a first communications standard;
encode, for transmission to the STA on the first channel of the first band, an association response, the association response comprising a second capabilities element for the first communications standard on the first band;
decode, from the STA on the first channel of the first band, a channel usage request frame, the channel usage request frame indicating a third capabilities element for a second communications standard on a second channel of a second band; and
decode, from the STA on the second channel of the second band, a data frame in accordance with the third capabilities element for the second communications standard.

19. The apparatus of claim 18, wherein the processing circuitry is further configured to: before the decode, from the STA on the second channel of the second band and after the decode, from the STA on the first channel of the first band the channel usage request frame:
encode, for transmission to the STA, a beacon frame, the beacon frame comprising an indication of the second channel of the second band and a fourth capabilities element for the second channel of the second band.

20. The apparatus of claim 18, wherein the processing circuitry is further configured to: before the decode, from the STA on the second channel of the second band and after the decode:
encode, for transmission to the STA, a beacon frame, the beacon frame comprising an indication of the second channel of the second band, a fourth capabilities element for the second channel of the second band, and a channel switch announcement (CSA), the CSA indicating the second channel of the second band.
